(19) United States
(12) Patent Application Publication
(10) Pub. No.: US 2009/0043069 A1
(43) Pub. Date: Feb. 12, 2009

(54) ACTIVATED ESTERS FOR SYNTHESIS OF SULFONATED TELECHELIC POLYCARBONATES

(75) Inventors: Daniel J. Brunelle, Burnt Hills, NY (US); Martino Colonna, Bologna (IT); Maurizio Fiorini, Anzola Emilia (BO) (IT); Corrado Berti, Lugo (RA) (IT); Enrico Binassi, Bologna (IT)

Correspondence Address: SABIC - LEXAN;SABIC Innovative Plastics - IP Legal, ONE PLASTICS AVE., PITTSFIELD, MA, 01201-3697, US

(73) Assignee: General Electric Company, Schenectady, NY (US)

(21) Appl. No.: 11/834,437

(22) Filed: Aug. 6, 2007

(51) Int. Cl. C08G 75/28

(52) U.S. Cl. 528/173

(57) ABSTRACT

A process of making a sulfonated telechelic polycarbonate is described. A dihydroxy compound, a carbonate ester, and an activated ester of a sulfobenzoic acid salt are reacted together. The method results in a sulfonated telechelic polycarbonate which has a high percentage of sulfonated end groups, is soluble, and is transparent.

### CROSS-REFERENCE TO RELATED APPLICATIONS

The present disclosure is related to the patent application entitled “POLYCARBONATE NANOCOMPOSITES,” concurrently filed (Atty Dkt. No. 220404-1, GEPL 2 00015), Ser. No. ______. The present disclosure is also related to the patent application entitled “SULFONATED TELECHELIC POLYCARBONATES”, concurrently filed (Atty Dkt. No. 220173-1, GEPL 2 00014(I)), Ser. No. ______. These disclosures are hereby fully incorporated herein by reference.

### BACKGROUND

The present disclosure relates to sulfonated telechelic polycarbonates and to methods of producing the same. For example, the disclosure relates, in certain embodiments, to the melt synthesis of sulfonated telechelic polycarbonates and to the compositions produced by such a process.

Polycarbonates are synthetic thermoplastic resins derived from bisphenols and phosgene, or their derivatives. They are linear polyesters of carbonic acid and can be formed from dihydroxy compounds and carbonate diesters, or by ester interchange. Their desired properties include clarity or transparency (i.e. 90% light transmission or more), high impact strength, heat resistance, weather and ozone resistance, good ductility, being combustible but self-extinguishing, good electrical resistance, noncorrosive, nontoxic, etc.

Polycarbonates can be manufactured by processes such as melt polymerization, i.e. melt synthesis. Generally, in the melt polymerization process, polycarbonates may be prepared by co-reacting, in a molten state, dihydroxy compound(s) and a diaryl carbonate ester in the presence of a transesterification catalyst in a Banburye mixer, twin screw extruder, or other batch stirred reactor designed to handle high viscous materials, to form a uniform dispersion. Volatile monohydric phenol is removed from the molten reactants by distillation and the polycarbonate polymer is isolated as a molten residue. Melt processes are generally carried out in a series of stirred tank reactors. The reaction can be carried out by either a batch mode or a continuous mode. The apparatus in which the reaction is carried out can be any suitable tank, tube, or column. Continuous processes usually involve the use of one or more continuous-stirred tank reactors (CSTRs) and one or more finishing reactors.

The presence of low concentrations of covalently bonded ionic substituents in organic polymers is well known to produce a consistent effect on their physical and rheological properties. Indeed, ionomers (polymers containing less than 10 mole percent of ionic groups) have been shown to exhibit considerably higher moduli and higher glass transition temperatures compared to those of their non-ionic analogues. Improvements in mechanical and thermal performance are generally attributed to the formation of ionic aggregates, which act as thermo-reversible cross-links and effectively retard the translational mobility of polymeric chains. The thermo-reversible nature of ionic aggregation may address many other disadvantages associated with covalently bonded high molecular weight polymers, such as poor melt processability, high melt viscosity, and low thermal stability at typical processing conditions such as high shear rate and temperature.

It is also reported in the literature that ionic interactions alter the crystallization kinetics and resulting morphology, decreasing the level of crystallinity. Telechelic ionomers (i.e. having only functionalized end groups) provide electrostatic interactions without a deleterious effect on the symmetry of the repeating unit. Moreover, the ionic aggregation will occur only at the end of the chain, giving rise to an electrostatic chain extension while random ionomers give rise to a gel-like or cross linked aggregation. For this reason, lower melt viscosities and higher molecular weights should be more easily obtained for telechelic ionomers compared to random ionomers.

U.S. Pat. No. 5,644,017 reported the preparation of telechelic polycarbonates by melt and interfacial methods. It claimed that polycarbonate ionomers presented a strong non-Newtonian melt rheology behavior along with increased solvent and flame resistance.

The '017 patent reported a melt method for the synthesis of telechelic sulfonated polycarbonates by a one-pot reaction of the phenyl ester of sulfobenzoate sodium salt (SBENa), bisphenol-A (BPA), and diphenyl carbonate (DPC). However, this method gave rise to a consistently high amount of degradation products. Furthermore, the material obtained was completely insoluble in dichloromethane. The dark yellow product was not soluble in any common organic solvents, nor in strong solvents such as hexafluoroisopropanol or trifluoroacetic acid, and therefore could not be characterized by GPC or NMR. This insolubility has been ascribed to crosslinking due to the formation of Fries rearrangement by-products. It may be due to the high catalyst content (25 ppm of lithium hydroxide) and/or the temperature program used during polymerization. The '017 patent also claimed two glass transition temperatures (at 148° C. and at 217° C.). This fact suggests the presence of two separable components: one with sulfonated end groups, and one without.

The '017 patent also reported solution methods for the preparation of telechelic sulfonated polycarbonates, via 3- or 4-chlorosulfonyl benzoic acid. Example 2 reported a Tg of 165° C. for the 4-isomer, but no Tg was reported in Example 3 for the 3-isomer. Both polymers had very low molecular weights; the 4-isomer had a M_{w} of 21,210 or a degree of polymerization (DP) of 44, while the 3-isomer had a much lower M_{w} (since 20% of the sulfonated end groups were incorporated) and a theoretical DP of only 8. Polycarbonates having a M_{w} of less than 30,000 are usually not useful because they lack the required mechanical properties. The polycarbonate of Example 3 also contained sulfonated groups as integral parts of the polymer backbone (i.e. not pendant from the chain). However, this type of mixed carbonic-sulfonic anhydride linkage is very thermally unstable and would ultimately cause the polycarbonate to fragment into two chains of lower molecular weight, especially during thermal processing. As such, any polycarbonate with anhydride functionality would not be very useful.

It would be desirable to provide telechelic sulfonated polycarbonates having low crosslinking and high transparency.

### BRIEF DESCRIPTION

Disclosed, in various embodiments, are telechelic sulfonated polycarbonates and methods for producing such polycarbonates.

In some embodiments, a method for the melt synthesis of a soluble telechelic sulfonated polycarbonate comprises:

reacting a mixture comprising a dihydroxy compound, an activated ester of sulfobenzoic acid salt, and an activated carbonate to obtain the telechelic sulfonated polycarbonate;

wherein the dihydroxy compound has the structure of Formula (I):

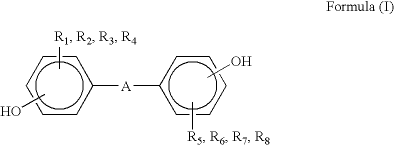

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic; the activated ester of sulfobenzoic acid salt has the structure of Formula (II):

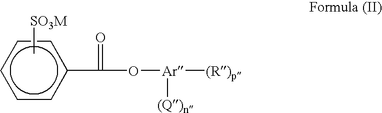

wherein M is an alkali metal; and Ar″ is an aromatic ring; each Q″ is independently selected from alkoxycarbonyl, halogen, nitro, amide, sulfone, sulfoxide, imine, and cyano; n″ is a whole number from 1 up to the number of replaceable hydrogen groups on the aromatic ring Ar″; each R″ is independently selected from alkyl, substituted alkyl, cycloalkyl, alkoxy, aryl, alkylaryl having from 1 to 30 carbon atoms, cyano, nitro, halogen, and carboalkoxy; and p″ is an integer from zero up to the number of replaceable hydrogen groups on the aromatic ring Ar″ minus n″; and

the activated carbonate has the structure of Formula (III):

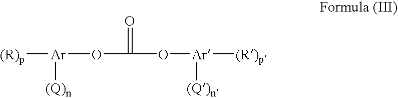

wherein each Q or Q′ is independently selected from alkoxycarbonyl, halogen, nitro, amide, sulfone, sulfoxide, imine, and cyano; Ar and Ar′ are independently aromatic rings; n and n′ are independently whole numbers from zero up to the number of replaceable hydrogen groups on the aromatic rings Ar and Ar′, wherein (n+n′)≧1; p is an integer from zero up to the number of replaceable hydrogen groups on the aromatic ring Ar minus n; p′ is an integer from zero up to the number of replaceable hydrogen groups on the aromatic ring Ar′ minus n′; and each R or R′ is independently selected from alkyl, substituted alkyl, cycloalkyl, alkoxy, aryl, alkylaryl having from 1 to 30 carbon atoms, cyano, nitro, halogen, and carboalkoxy.

The sulfobenzoic acid salt may be the methyl salicyl ester of sulfobenzoic acid sodium salt.

The reacting step may occur at a temperature of from about 200° C. to about 270° C.

The reacting step may occur for a period of from about 60 minutes to about 120 minutes.

The reacting step may occur at a pressure of from about 0.1 millibar to about 1500 millibar.

The reacting step may comprise:

heating the mixture to about 210° C. for about 60 minutes;

increasing the temperature to about 240° C., reducing the pressure to about 130 millibar, and maintaining the temperature and pressure for about 10 minutes;

increasing the temperature to about 260° C. over about 10 minutes, decreasing the pressure to about 0.2 millibar, and maintaining the temperature and pressure for about 75 minutes.

In other embodiments, the method for the synthesis of a telechelic sulfonated polycarbonate may comprise reacting a mixture comprising bisphenol-A, the methyl salicyl ester of sulfobenzoic acid sodium salt, bis(methylsalicyl)carbonate (BMSC), and a catalyst to obtain the telechelic sulfonated polycarbonate.

In other embodiments, the method for the melt synthesis of a telechelic sulfonated polycarbonate may comprise:

providing a mixture comprising a dihydroxy compound, an activated ester of sulfobenzoic acid salt, and an activated carbonate;

heating the mixture heated to a starting temperature of from about 200° C. to about 220° C. at a starting pressure of from about 0.5 bar to about 1.5 bar for a starting period of from about 50 to about 70 minutes;

increasing the temperature to about 240° C., reducing the pressure to about 130 millibar, and maintaining the temperature and pressure for about 10 minutes;

increasing the temperature to about 260° C. over about 10 minutes, decreasing the pressure to about 0.2 millibar, and maintaining the temperature and pressure for about 75 minutes to obtain the telechelic sulfonated polycarbonate.

In still other embodiments, the method of making a soluble telechelic sulfonated polycarbonate may comprise:

heating a reaction mixture comprising a dihydroxy compound, a sulfobenzoic acid salt, and a diaryl carbonate ester to a starting temperature of from about 210° C. to about 230° C.;

holding the reaction mixture at a first temperature of from about 170° C. to about 190° C. for a first period of from about 10 to about 20 minutes at a first pressure of from about 900 millibar to about 1500 millibar;

holding the reaction mixture at a second temperature of from about 200° C. to about 220° C. for a second period of from about 20 to about 40 minutes at a second pressure of from about 100 millibar to about 200 millibar; and

holding the reaction mixture at a third temperature of from about 230° C. to about 250° C. for a third period of from about 20 to about 40 minutes at a third pressure of from about 10 millibar to about 30 millibar;

wherein the reaction mixture is heated for a total of from about 90 to about 120 minutes;

to obtain the soluble telechelic sulfonated polycarbonate.

The method may further comprise:

holding the reaction mixture at a fourth temperature of from about 260° C. to about 280° C. for a fourth period of from about 5 to about 15 minutes at a fourth pressure of from about 2 millibar to about 5 millibar; and

holding the reaction mixture at a fifth temperature of from about 300° C. to about 320° C. for a fifth period of from about 15 to about 25 minutes at a fifth pressure of from about 0.2 millibar to about 1 millibar.

In specific embodiments, the starting temperature is about 220° C.;

the first temperature is about 180° C., the first period is about 15 minutes, and the first pressure is about 1000 millibar;

the second temperature is about 210° C., the second period is about 30 minutes, and the second pressure is about 130 millibar

the third temperature is about 240° C., the third period is about 30 minutes, and the third pressure is about 20 millibar

the fourth temperature is about 270° C., the fourth period is about 10 minutes, and the fourth pressure is about 2.5 millibar; and

the fifth temperature is about 310° C., the fifth period is about 20 minutes, and the fifth pressure is about 0.5 millibar.

The sulfobenzoic acid salt may be the phenyl ester of 3-sulfobenzoic acid sodium salt and the diaryl carbonate ester may be diphenyl carbonate.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a diagram illustrating the methods of the present disclosure.

FIG. 2 is a set of ¹H-NMR spectra of the telechelic sulfonated polycarbonate produced by the methods of the present disclosure.

### DETAILED DESCRIPTION

A more complete understanding of the components, processes and apparatuses disclosed herein can be obtained by reference to the accompanying drawings. These drawings are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

As used herein, “polycarbonate” refers to an oligomer or polymer comprising residues of one or more dihydroxy compounds joined by carbonate linkages. The term “polycarbonate” also encompasses poly(carbonate-co-ester) oligomers and polymers.

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

The methods comprise reacting a mixture comprising a dihydroxy compound, an activated ester of a sulfobenzoic acid salt, and an activated carbonate to obtain a telechelic sulfonated polycarbonate. The dihydroxy compound has the structure of Formula (I):

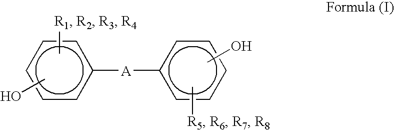

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl)propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

The activated ester of a sulfobenzoic acid salt has the structure of Formula (II):

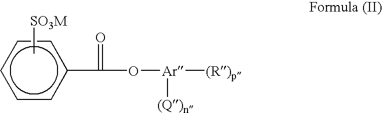

wherein M is an alkali metal; and Ar″ is an aromatic ring; each Q″ is independently selected from alkoxycarbonyl, halogen, nitro, amide, sulfone, sulfoxide, imine, and cyano; n″ is a whole number from 1 up to the number of replaceable hydrogen groups on the aromatic ring Ar″; each R″ is independently selected from alkyl, substituted alkyl, cycloalkyl, alkoxy, aryl, alkylaryl having from 1 to 30 carbon atoms, cyano, nitro, halogen, and carboalkoxy; and p″ is an integer. The number of R″ groups, p″, is an integer and can be zero up to the number of replaceable hydrogen groups on the aromatic ring Ar″ minus the number n″. The number and type of the R″ substituents is not limited unless they deactivate the ester. Typically, the R″ substituents are located in the para, ortho, or a combination of the two positions.

In specific embodiments, M is sodium; Ar″ is phenyl; Q″ is methylsalicyl; and n″ is 1. This is the methyl salicyl ester of sulfobenzoic acid sodium salt. In other specific embodiments, the sulfobenzoic acid salt is the 3-sulfobenzoic acid salt (i.e. the sulfonate group is in the meta position to the ester group).

If desired, the dihydroxy compound and activated ester of sulfobenzoic acid salt may first be reacted together to improve the solubility of the salt before the activated carbonate is added for reaction. This method is described in related U.S. patent application Ser. No. ______, entitled “SULFONATED TELECHELIC POLYCARBONATES”, concurrently filed (Atty Dkt. No. 220173-1, GEPL 2 00014(I)). However, such a pre-reaction step is not necessary with an activated ester.

One method for determining whether a certain ester of sulfobenzoic acid salt is activated or is not activated is to carry out a model transesterification reaction between the certain ester of sulfobenzoic acid salt with phenol. The model transesterification reaction is generally carried out in the presence of a transesterification catalyst, which is usually an aqueous solution of sodium hydroxide or sodium phenoxide. The choice of conditions and catalyst concentration can be adjusted depending on the reactivity of the reactants and melting points of the reactants to provide a convenient reaction rate. The only limitation to reaction temperature is that the temperature must be below the degradation temperature of the reactants. The determination of the equilibrium concentration of reactants is accomplished through reaction sampling during the course of the reaction and then analysis of the reaction mixture using a well-know detection method to those skilled in the art such as HPLC (high pressure liquid chromatography). Particular care needs to be taken so that reaction does not continue after the sample has been removed from the reaction vessel. The equilibrium constant can be determined from the concentration of the reactants and product when equilibrium is reached. Equilibrium is assumed to have been reached when the concentration of components in the reaction mixture reach a point of little or no change on sampling of the reaction mixture. The equilibrium constant can be determined from the concentration of the reactants and products at equilibrium by methods well known to those skilled in the art. An ester of sulfobenzoic acid salt which possesses an equilibrium constant of greater than 1 is considered to possess a more favorable equilibrium than the phenyl ester of sulfobenzoic acid salt and is an activated ester of sulfobenzoic acid salt. An ester of sulfobenzoic acid salt which possesses an equilibrium constant of 1 or less is considered to possess the same or a less favorable equilibrium than the phenyl ester of sulfobenzoic acid salt diphenyl carbonate and is considered to be not activated. Use of an activated ester of sulfobenzoic acid salt allows polymerization in a shorter time and at lower temperatures.

The molar ratio of dihydroxy compound to activated ester of sulfobenzoic acid salt can be from about 99.9:0.1 to about 90:10. In specific embodiments, the molar ratio is about 97:3. This ensures a sufficient amount of dihydroxy compound is available to react with the activated ester of sulfobenzoic acid salt and also ensures that the activated ester of sulfobenzoic acid salt becomes a terminal end group.

The mixture further comprises an activated carbonate. As used herein, the term “activated carbonate” is defined as a diaryl carbonate ester which is more reactive than diphenyl carbonate toward transesterification reactions. Such activated carbonates have the structure of Formula (III):

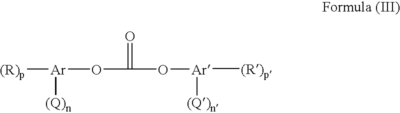

wherein each Q or Q′ is independently an activating group; Ar and Ar′ are independently aromatic rings; n and n′ are independently whole numbers from zero up to the number of replaceable hydrogen groups substituted on the aromatic rings Ar and Ar′, wherein (n+n′)≧1; p and p′ are integers; and each Ror R′ is independently selected from alkyl, substituted alkyl, cycloalkyl, alkoxy, aryl, alkylaryl having from 1 to 30 carbon atoms, cyano, nitro, halogen, and carboalkoxy. The number of R groups, p, is an integer and can be zero up to the number of replaceable hydrogen groups on the aromatic ring Ar minus the number n. The number of R′ groups, p′, is an integer and can be zero up to the number of replaceable hydrogen groups on the aromatic ring Ar′ minus the number n′. The number and type of the R and R′ substituents on the aromatic rings Ar and Ar′ are not limited unless they deactivate the carbonate and lead to a carbonate which is less reactive than diphenyl carbonate. Typically, the R and R′ substituents are located in the para, ortho, or a combination of the two positions.

Non-limiting examples of activating groups Q and Q′ are: alkoxycarbonyl groups, halogens, nitro groups, amide groups, sulfone groups, sulfoxide groups, imine groups, and cyano groups.

Specific and non-limiting examples of activated carbonates include:
bis(o-methoxycarbonylphenyl)carbonate;
bis(o-chlorophenyl)carbonate;
bis(o-nitrophenyl)carbonate;
bis(o-acetylphenyl)carbonate;
bis(o-phenylketonephenyl)carbonate;
bis(o-formylphenyl)carbonate; and
bis(o-cyanophenyl)carbonate.
   Unsymmetrical combinations of these structures, where the substitution number and type on Ar and Ar′ are different, may also be used.

A preferred structure for an activated carbonate is an ester-substituted diaryl carbonate having the structure of Formula (IV):

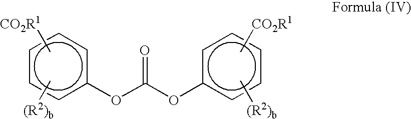

wherein R¹ is independently a C₁-C₂₀ alkyl radical, C₄-C₂₀ cycloalkyl radical, or C₄-C₂₀ aromatic radical; R² is independently a halogen atom, cyano group, nitro group, C₁-C₂₀ alkyl radical, C₄-C₂₀ cycloalkyl radical, C₄-C₂₀ aromatic radical, C₁-C₂₀ alkoxy radical, C₄-C₂₀ cycloalkoxy radical, C₄-C₂₀ aryloxy radical, C₁-C₂₀ alkylthio radical, C₄-C₂₀ cycloalkylthio radical, C₄-C₂₀ arylthio radical, C₁-C₂₀ alkylsulfinyl radical, C₄-C₂₀ cycloalkylsulfinyl radical, C₄-C₂₀ arylsulfinyl radical, C₁-C₂₀ alkylsulfonyl radical, C₄-C₂₀ cycloalkylsulfonyl radical, C₄-C₂₀ arylsulfonyl radical, C₁-C₂₀ alkoxycarbonyl radical, C₄-C₂₀ cycloalkoxycarbonyl radical, C₄-C₂₀ aryloxycarbonyl radical, C₂-C₆₀ alkylamino radical, C₆-C₆₀ cycloalkylamino radical, C₅-C₆₀ arylamino radical, C₁-C₄₀ alkylaminocarbonyl radical, C₄-C₄₀ cycloalkylaminocarbonyl radical, C₄-C₄₀ arylaminocarbonyl radical, or C₁-C₂₀ acylamino radical; and b is independently at each occurrence an integer from zero to 4. Preferably, at least one of the substituents CO₂R¹ is attached in an ortho position relative to the carbonate group.

Examples of preferred ester-substituted diaryl carbonates include, but are not limited to, bis(methylsalicyl)carbonate (BMSC) (CAS Registry No. 82091-12-1), bis(ethyl salicyl)carbonate, bis(propyl salicyl) carbonate, bis(butylsalicyl) carbonate, bis(benzyl salicyl)carbonate, bis(methyl 4-chlorosalicyl)carbonate and the like. Typically bis(methylsalicyl)carbonate is preferred for use in melt polycarbonate synthesis due to its preparation from less expensive raw materials, lower molecular weight and higher vapor pressure.

One method for determining whether a certain diaryl carbonate is activated or is not activated is to carry out a model transesterification reaction between the certain diaryl carbonate with a phenol such as para-cumyl phenol. This phenol is preferred because it possesses only one reactive site, possesses a low volatility, and possesses a similar reactivity to bisphenol-A. The model transesterification reaction is carried out at temperatures above the melting points of the certain diaryl carbonate and para-cumyl phenol and in the presence of a transesterification catalyst, which is usually an aqueous solution of sodium hydroxide or sodium phenoxide. Preferred concentrations of the transesterification catalyst are about 0.001 mole % based on the number of moles of the phenol or diaryl carbonate. A preferred reaction temperature is 200° C. The choice of conditions and catalyst concentration can be adjusted depending on the reactivity of the reactants and melting points of the reactants to provide a convenient reaction rate. The only limitation to reaction temperature is that the temperature must be below the degradation temperature of the reactants. Sealed tubes can be used if the reaction temperatures cause the reactants to volatilize and affect the reactant molar balance. The determination of the equilibrium concentration of reactants is accomplished through reaction sampling during the course of the reaction and then analysis of the reaction mixture using a well-know detection method to those skilled in the art such as HPLC (high pressure liquid chromatography). Particular care needs to be taken so that reaction does not continue after the sample has been removed from the reaction vessel. This is accomplished by cooling down the sample in an ice bath and by employing a reaction quenching acid such as acetic acid in the water phase of the HPLC solvent system. It may also be desirable to introduce a reaction quenching acid directly into the reaction sample in addition to cooling the reaction mixture. A preferred concentration for the acetic acid in the water phase of the HPLC solvent system is 0.05% (v/v). The equilibrium constant can be determined from the concentration of the reactants and product when equilibrium is reached. Equilibrium is assumed to have been reached when the concentration of components in the reaction mixture reach a point of little or no change on sampling of the reaction mixture. The equilibrium constant can be determined from the concentration of the reactants and products at equilibrium by methods well known to those skilled in the art. A diaryl carbonate which possesses an equilibrium constant of greater than 1 is considered to possess a more favorable equilibrium than diphenyl carbonate and is an activated carbonate, whereas a diaryl carbonate which possesses an equilibrium constant of 1 or less is considered to possess the same or a less favorable equilibrium than diphenyl carbonate and is considered to be not activated. It is generally preferred to employ an activated carbonate with very high reactivity compared to diphenyl carbonate when conducting transesterification reactions. Preferred are activated carbonates with an equilibrium constant at least 10 times greater than that of diphenyl carbonate. Use of activated carbonate allows polymerization in a shorter time and at lower temperatures.

Some non-limiting examples of non-activating groups which, when present in an ortho position relative to the carbonate group, would not be expected to result in activated carbonates are alkyl and cycloalkyl. Some specific and non-limiting examples of non-activated carbonates are bis(o-methylphenyl)carbonate, bis(p-cumylphenyl)carbonate, and bis(p-(1,1,3,3-tetramethyl)butylphenyl)carbonate. Unsymmetrical combinations of these structures are also expected to result in non-activated carbonates.

The mixture may further comprise a catalyst. In specific embodiments, the catalyst system comprises tetramethyl ammonium hydroxide (TMAH) and sodium hydroxide (NaOH). The weight ratio of TMAH to NaOH can be from about 100 to about 500 and in specific embodiments is about 263. Other suitable catalysts for use in polycarbonate synthesis include those described in U.S. Pat. Nos. 6,376,640; 6,303,737; 6,323,304; 5,650,470; and 5,412,061.

The reacting step may occur at a temperature of from about 200° C. to about 270° C. The reacting step may occur for a period of from about 60 minutes to about 120 minutes. The reacting step may occur at a pressure of from about 0.1 millibar to about 1500 millibar.

The temperature and pressure may be varied during the reacting step. For example, the pressure may begin around atmospheric pressure and be reduced to a pressure of from about 0.01 millibar to about 2 millibar during the reaction. This pressure reduction can be done in stages. Similarly, the temperature may begin at a starting temperature and be increased during the reaction. The temperature and pressure may also be varied and held at certain levels for certain periods of time during this reaction as well.

In specific embodiments, the mixture is heated to a starting temperature of from about 200° C. to about 220° C. at a starting pressure of from about 0.5 bar to about 1.5 bar for a starting period of from about 50 to about 70 minutes. Next, the temperature is increased to a first temperature of from about 235° C. to about 245° C., the pressure is reduced to a first pressure of about 120 millibar to about 140 millibar, and the temperature and pressure are maintained for a first period of from about 5 minutes to about 15 minutes. The temperature is then increased to a second temperature of from about 255° C. to about 265° C. over a second period of from about 5 minutes to about 15 minutes, the pressure is decreased to a second pressure of from about 0.1 millibar to about 0.5 millibar, and the temperature and pressure are maintained for a third period of from about 70 minutes to about 80 minutes to obtain the telechelic sulfonated polycarbonate.

In further specific embodiments, the mixture is heated to a starting temperature of from about 200° C. to about 220° C. at a starting pressure of from about 0.5 bar to about 1.5 bar for a starting period of from about 50 to about 70 minutes. The temperature is then increased to about 240° C., the pressure is reduced to about 130 millibar, and held there for about 10 minutes. The temperature is then increased to about 260° C. over 10 minutes, the pressure is reduced to about 0.2 millibar (i.e. as close to full vacuum as possible), and held there for about 75 minutes. The pressure is slowly reduced so that the reaction does not boil too quickly.

A pale yellow and transparent telechelic sulfonated polycarbonate can be obtained from the processes of the present disclosure. The telechelic sulfonated polycarbonate may have the structure of Formula (V):

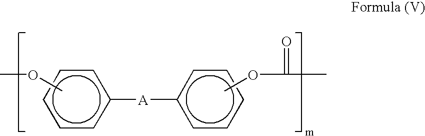

wherein A is selected from a bond, —O—, —S—, —SO₂—, C₁-C₁₂ alkyl, C₆-C₂₀ aromatic, and C₆-C₂₀ cycloaliphatic; and m is the degree of polymerization;

wherein at least 70 mole percent of the end groups of the polycarbonate are sulfonates of Formula (VI):

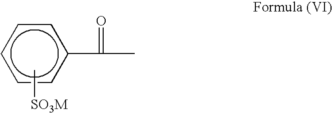

wherein M is an alkali metal.

In other embodiments, a telechelic polycarbonate is formed wherein at least 70 mole percent of the end groups of the polycarbonate are sulfonates of Formula (VI) and the polycarbonate contains no sulfonate groups in the polycarbonate backbone.

The processes of the present disclosure provide a yield of at least 70% of the sulfonated telechelic polycarbonate.

The telechelic sulfonated polycarbonate of the present disclosure is completely soluble in solvents such as hexafluoroisopropanol and chloroform. It also has high ionic content and low Fries by-products. In comparison, the polycarbonate produced by the '017 patent has reduced solubility in chlorinated solvents.

The telechelic sulfonated polycarbonate of the present disclosure has a weight average molecular weight of greater than 30,000. In specific embodiments, it has a Mw of about 32,000.

The telechelic sulfonated polycarbonate of the present disclosure is transparent.

In other embodiments, the methods of obtaining a telechelic sulfonated polycarbonate comprise providing a mixture comprising a dihydroxy compound, a sulfobenzoic acid salt, and a diaryl carbonate ester. Here, the term “diaryl carbonate ester” encompasses diphenyl carbonate (DPC) along with any of the activated carbonates previously described. The sulfobenzoic acid salt does not need to be activated. In other words, with reference to Formula (II), n″ can be zero (i.e. the phenyl ester of sulfobenzoic acid salt). The mixture is then raised to a starting temperature. The mixture is then cooled to and held at a first temperature which is lower than the starting temperature for a first period of time at a first pressure. The temperature is then increased to a second temperature, decreased to a second pressure, and held for a second period of time. The temperature is then increased to a third temperature, decreased to a third pressure, and held for a third period of time. The total reaction time is from about 90 to about 120 minutes. A telechelic sulfonated polycarbonate is thus obtained. If desired, there can be additional steps at which the mixture is held at a certain temperature and pressure.

A catalyst may be added to the mixture prior to or after raising the mixture to the starting temperature.

The starting temperature may be from about 210° C. to about 230° C. If desired, the reaction can be performed in a non-oxygen atmosphere, such as argon. In particular embodiments, the starting temperature is 220° C.

The first temperature can be from about 170° to about 190° C. The first pressure can be from about 900 millibar to about 1500 millibar. The first period of time can be from about 10 to about 20 minutes. In particular embodiments, the first temperature is about 180° C. In particular embodiments, the first pressure is about 1000 millibar. In particular embodiments, the first period of time is about 15 minutes.

The second temperature can be from about 200° to about 220° C. The second pressure can be from about 100 millibar to about 200 millibar. The second period of time can be from about 20 to about 40 minutes. In particular embodiments, the second temperature is about 210° C. In particular embodiments, the second pressure is about 130 millibar. In particular embodiments, the second period of time is about 30 minutes.

The third temperature can be from about 230° to about 250° C. The third pressure can be from about 10 millibar to about 30 millibar. The third period of time can be from about 20 to about 40 minutes. In particular embodiments, the third temperature is about 240° C. In particular embodiments, the third pressure is about 20 millibar. In particular embodiments, the third period of time is about 30 minutes.

In additional embodiments, the process further comprises two additional holding steps. The temperature is increased to a fourth temperature, decreased to a fourth pressure, and held for a fourth period of time. The temperature then is increased to a fifth temperature, decreased to a fifth pressure, and held for a fifth period of time.

The fourth temperature can be from about 260° to about 280° C. The fourth pressure can be from about 2 millibar to about 5 millibar. The fourth period of time can be from about 5 to about 15 minutes. In particular embodiments, the fourth temperature is about 270° C. In particular embodiments, the fourth pressure is about 2.5 millibar. In particular embodiments, the fourth period of time is about 10 minutes.

The fifth temperature can be from about 300° to about 320° C. The fifth pressure can be from about 0.2 millibar to about 1 millibar. The fifth period of time can be from about 15 to about 25 minutes. In particular embodiments, the fifth temperature is about 310° C. In particular embodiments, the fifth pressure is about 0.5 millibar. In particular embodiments, the fifth period of time is about 20 minutes.

In specific embodiments, the reaction mixture comprises a dihydroxy compound, a phenyl ester (activated or non-activated) of sulfobenzoic acid salt, and a diaryl carbonate ester (activated or non-activated).

In other specific embodiments, there are five holding steps; the starting temperature is about 220° C.; the first temperature is about 180° C., the first period is about 15 minutes, and the first pressure is about 1000 millibar; the second temperature is about 210° C., the second period is about 30 minutes, and the second pressure is about 130 millibar; the third temperature is about 240° C., the third period is about 30 minutes, and the third pressure is about 20 millibar; the fourth temperature is about 270° C., the fourth period is about 10 minutes, and the fourth pressure is about 2.5 millibar; and the fifth temperature is about 310° C., the fifth period is about 20 minutes, and the fifth pressure is about 0.5 millibar.

The telechelic sulfonated polycarbonates obtained using these methods are also soluble in chloroform. Although the '017 patent uses similar starting reactants, it does not result in a soluble sulfonated polycarbonate when using a melt synthesis process.

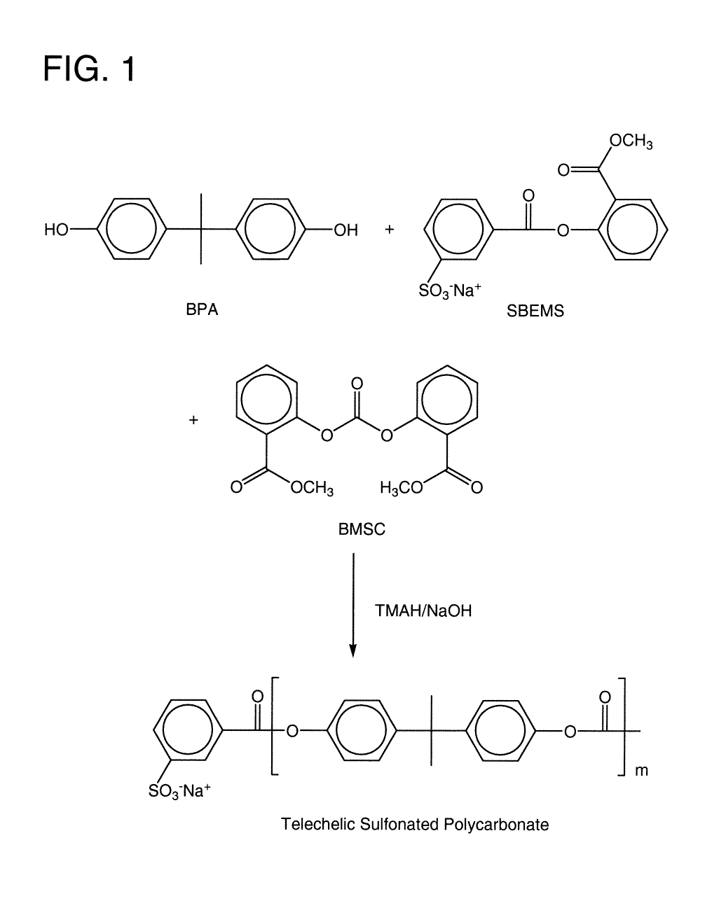

FIG. 1 is a diagram illustrating the methods of the present disclosure. In this diagram, exemplary compounds BPA, methyl salicyl ester of sulfobenzoic acid sodium salt (SBEMS), and BMSC are used. The three compounds are reacted together to form a telechelic sulfonated polycarbonate.

The methods described herein are also applicable to polycarbonates and copolymers prepared from mixtures and/or combinations of dihydroxy compounds, sulfobenzoic acid salts, and activated carbonates.

The following examples are provided to illustrate the polycarbonate compositions, articles, and methods of the present disclosure. The examples are merely illustrative and are not intended to limit the disclosure to the materials, conditions, or process parameters set forth therein.

### EXAMPLES

### Example 1

Part 1: Preparation of methyl salicyl ester of sulfobenzoic acid sodium salt (SBEMS).

A 100 mL, 3-neck flask equipped with nitrogen purge, magnetic stirrer and condenser is filled with 2.425 g (10.8 mmol) of sodium 3-sulfobenzoic acid, 4.28 g (12.96 mmol) of bis(o-methylsalicyl)carbonate (BMSC) and 0.023 g (0.216 mmol) of sodium carbonate. 25 ml of dimethylformamide (DMF) are added, and then the flask is placed under a nitrogen atmosphere and heated to reflux. After 8 hours the reaction is complete. 100 ml of distilled water are then added and extracted 4 times with dichloromethane (DCM). The aqueous phase is dried under reduced pressure and the residue is eventually washed with DCM in order to remove the residual DMF. The final yield is 70%. The product was characterized by ¹H-NMR analysis.

Part 2: Preparation of Sulfonated Telechelic Polycarbonate

A round bottom wide-neck glass reactor (250 ml capacity) was charged with bisphenol-A (BPA) (25.30 g; 110.8 mmol), BMSC (36.95 g; 111.9 mmol), SBEMS (1.00 g; 3.32 mmol) and catalyst (a mixture of 2.22×10⁻² mmol tetramethylammonium hydroxide (TMAH) and 8.43×10⁻⁵ mmol of NaOH).

The reactor was closed with a three-neck flat flange lid equipped with a mechanical stirrer and a torque meter. The system was then connected to a water cooled condenser and immersed in a thermostatic oil-bath at 210° C. and the stirrer switched on at 140 rpm. After 60 min. the temperature was increased to 240° C. and dynamic vacuum was applied at 130 mbar for 10 minutes. The temperature was then increased to 260° C. in 10 minute and the pressure decreased to 0.2 mbar. The reaction melt was very viscous after 10 minutes from the application of dynamic vacuum and the stirring was very difficult and slow in the last part of the polymerization. After 75 minutes from the application of the full vacuum, the very viscous pale yellow and transparent melt was discharged from the reactor and analyzed by ¹H-NMR, GPC, DSC and TGA.

### Example 2

A 250 mL glass reactor was filled with diphenyl carbonate (DPC) (11.92 g, 55.7 millimoles), BPA (12.08 g, 53 millimoles), and 3-sulfobenzoate sodium salt (3-SBENa) (0.477 g, 1.59 millimoles). The reactor was evacuated and purged with nitrogen 3 times and then the reaction mixture was heated to 220° C. under an argon atmosphere. Aqueous NaOH (13.0 μL of 0.15 M solution) and TMAH (13.0 μL of 1M solution) were injected into the stirred reaction mixture resulting in immediate vigorous boiling. The reaction was kept at 180° C. at atmospheric pressure for 15 minutes. The temperature was then increased to 210° C. and the pressure was reduced down to 250 millibar, then down to 130 millibar for 30 minutes. The temperature was then increased to 240° C. and the pressure was reduced to 20 millibar and kept at these conditions for an additional 30 minutes. The temperature was then increased to 270° C. and the pressure reduced to 2.5 millibar and kept at these conditions for an additional 10 minutes. The temperature was then increased to 310° C. and the pressure was reduced to 0.5 millibar and kept at these conditions for an additional 20 minutes. The final, yellow, very viscous material was recovered from the reactor. The final material was completely soluble in CHCl₃. The ¹H-NMR analysis showed the presence of Fries rearrangement by-products.

### Comparative Example 1

For comparison, a sulfonated polycarbonate was prepared according to Example 4 of U.S. Pat. No. 5,644,017. A 250 mL glass reactor was filled with (DPC) (11.92 g, 55.7 millimoles), BPA (12.08 g, 53 millimoles), and 3-SBENa (0.477 g, 1.59 millimoles). The reactor was evacuated and purged with nitrogen 3 times and then the reaction mixture was heated to 220° C. under an argon atmosphere. Aqueous LiOH (10.7 μL of 0.132M solution) was injected into the stirred reaction mixture resulting in immediate vigorous boiling. The reaction pressure was reduced to 40 millibar in 25 min and then down to 0.1 millibar. At this point the reaction melt was viscous. The reaction temperature was increased to 280° C. and maintained at that temperature for 5 minutes at full vacuum (0.1 millibar). The final, dark yellow, very viscous material was recovered from the reactor. The material was not soluble in CHCl₃, CF₃COOH, or hexafluoroisopropanol.

### Analysis

Example 1 was analyzed by GPC, TGA, and DSC. According to GPC, the Mw of the polycarbonate prepared by Example 1 was about 32,000. According to TGA, the Tₒₙₛₑₜ of the polycarbonate prepared by Example 1 was 404° C. According to DSC, the glass transition temperature (Tg) was 147° C.

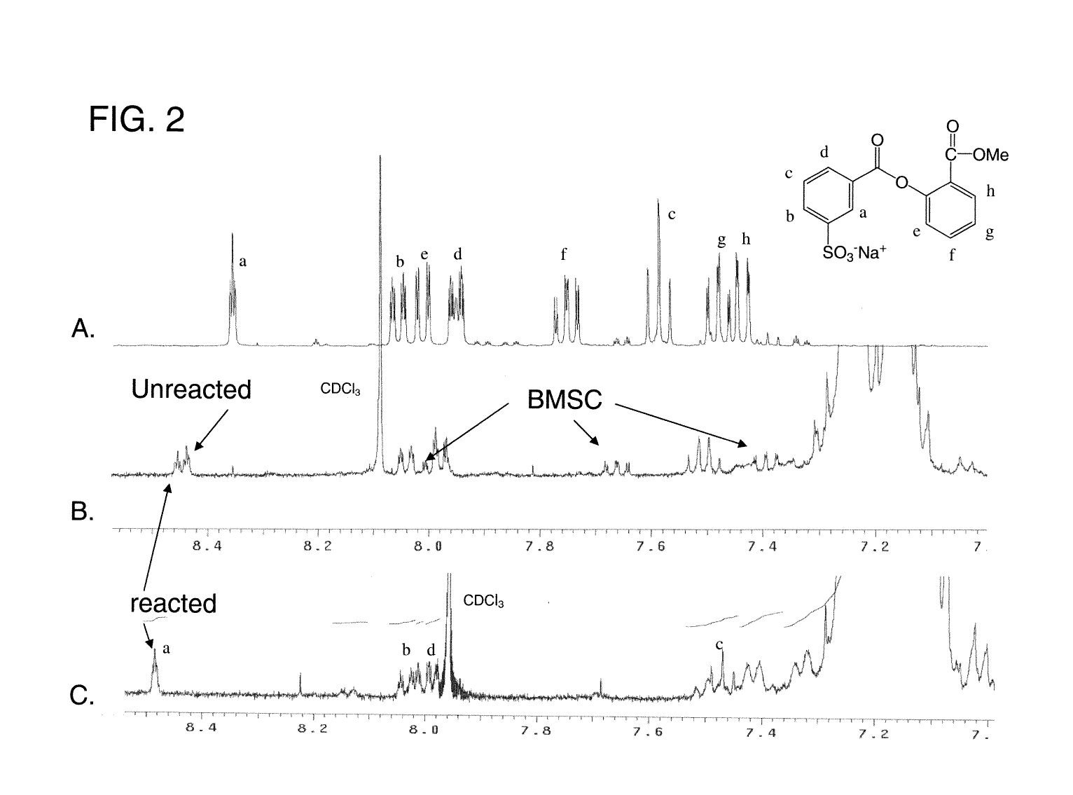

FIG. 2 is a set of ¹H-NMR spectra showing the progress of the reaction of Example 1. Spectrum 2A is that of SBEMS in DMSO solvent. The peaks are labelled according to the protons attached to the carbon atoms shown on SBEMS. Peak a, at around 8.35 ppm, represents the proton of the carbon adjacent to the sulfonated group. Spectrum 2B is a sample taken after 30 minutes. The solvent is DMSO/CDCl₃ 50:50 v/v. The large peak at about 8.1 ppm is CDCl₃. As the polymerization proceeds, an unreacted peak corresponds to the starting SBEMS and a reacted peak corresponds to the same proton, but on the ester attached to an end of the polycarbonate chain. The unreacted and reacted (i.e. attached to the polycarbonate) peaks of SBEMS are labelled, as are the peaks corresponding to BMSC. Formation of the sodium sulfobenzoate attached to the polycarbonate is indicated by the peak centered around 7.2 ppm. Spectrum 2C is the final polymer. The solvent is DMSO/CDCl₃ 70:30 v/v. Only sodium sulfobenzoate attached to the polycarbonate is seen from the peak at ˜8.5 ppm, with no SBEMS observed. The change in the CDCl₃ peaks is due to differences in the solvent of Spectra 2B and 2C.

Comparative Example 1 shows that the methods of the '017 patent produce a crosslinked, insoluble sulfonated polycarbonate. Examples 1 and 2, on the other hand, provide a soluble, non-crosslinked polycarbonate. As noted though, Example 2 did have Fries byproducts, whereas the polycarbonate of Example 1 did not.

The methods of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A method for the melt synthesis of a soluble telechelic sulfonated polycarbonate, comprising:
reacting a mixture comprising a dihydroxy compound, an activated ester of sulfobenzoic acid salt, and an activated carbonate to obtain the telechelic sulfonated polycarbonate;
wherein the dihydroxy compound has the structure of Formula (I): 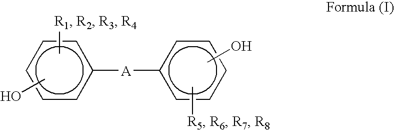
wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic;
the activated ester of sulfobenzoic acid salt has the structure of Formula (II): 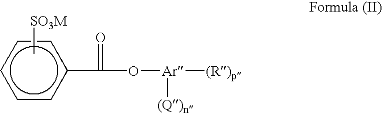
wherein M is an alkali metal; and Ar″ is an aromatic ring; each Q″ is independently selected from alkoxycarbonyl, halogen, nitro, amide, sulfone, sulfoxide, imine, and cyano; n″ is a whole number from 1 up to the number of replaceable hydrogen groups on the aromatic ring Ar″; each R″ is independently selected from alkyl, substituted alkyl, cycloalkyl, alkoxy, aryl, alkylaryl having from 1 to 30 carbon atoms, cyano, nitro, halogen, and carboalkoxy; and p″ is an integer from zero up to the number of replaceable hydrogen groups on the aromatic ring Ar″ minus n″; and
the activated carbonate has the structure of Formula (III): 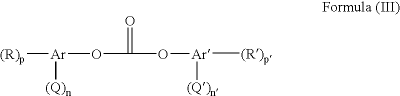
wherein each Q or Q′ is independently selected from alkoxycarbonyl, halogen, nitro, amide, sulfone, sulfoxide, imine, and cyano; Ar and Ar′ are independently aromatic rings; n and n‘are independently whole numbers from zero up to the number of replaceable hydrogen groups on the aromatic rings Ar and Ar’, wherein (n+n′)≦1; p is an integer from zero up to the number of replaceable hydrogen groups on the aromatic ring Ar minus n; p′ is an integer from zero up to the number of replaceable hydrogen groups on the aromatic ring Ar′ minus n′; and each R or R′ is independently selected from alkyl, substituted alkyl, cycloalkyl, alkoxy, aryl, alkylaryl having from 1 to 30 carbon atoms, cyano, nitro, halogen, and carboalkoxy.

2. The method of claim 1, wherein the sulfobenzoic acid salt is the methyl salicyl ester of sulfobenzoic acid sodium salt.

3. The method of claim 1, wherein the reacting step occurs at a temperature of from about 200° C. to about 270° C.

4. The method of claim 1, wherein the reacting step occurs for a period of from about 60 minutes to about 120 minutes.

5. The method of claim 1, wherein the reacting step occurs at a pressure of from about 0.1 millibar to about 1500 millibar.

6. The method of claim 1, wherein the reacting step comprises:
heating the mixture to about 210° C. for about 60 minutes;
increasing the temperature to about 240° C., reducing the pressure to about 130 millibar, and maintaining the temperature and pressure for about 10 minutes;
increasing the temperature to about 260° C. over about 10 minutes, decreasing the pressure to about 0.2 millibar, and maintaining the temperature and pressure for about 75 minutes.

7. A method for the synthesis of a telechelic sulfonated polycarbonate, comprising:
reacting a mixture comprising bisphenol-A, the methyl salicyl ester of sulfobenzoic acid sodium salt, bis(methylsalicyl)carbonate (BMSC), and a catalyst to obtain the telechelic sulfonated polycarbonate.

8. A method for the melt synthesis of a telechelic sulfonated polycarbonate, comprising:
providing a mixture comprising a dihydroxy compound, an activated ester of sulfobenzoic acid salt, and an activated carbonate;
heating the mixture to a starting temperature of from about 200° C. to about 220° C. at a starting pressure of from about 0.5 bar to about 1.5 bar for a starting period of from about 50 to about 70 minutes;
increasing the temperature to a first temperature of from about 235° C. to about 245° C., reducing the pressure to a first pressure of about 120 millibar to about 140 millibar, and maintaining the temperature and pressure for a first period of from about 5 minutes to about 15 minutes; and
increasing the temperature to a second temperature of from about 255° C. to about 265° C. over a second period of from about 5 minutes to about 15 minutes, decreasing the pressure to a second pressure of from about 0.1 millibar to about 0.5 millibar, and maintaining the temperature and pressure for a third period of from about 70 minutes to about 80 minutes to obtain the telechelic sulfonated polycarbonate.

9. The method of claim 8, wherein the first temperature is about 240° C., the first pressure is about 130 millibar, the first period is about 10 minutes;
the second temperature is about 260° C., the second period is about 10 minutes, the second pressure is about 0.2 millibar; and
the third period is about 75 minutes.

10. A method of making a soluble telechelic sulfonated polycarbonate, comprising:
heating a reaction mixture comprising a dihydroxy compound, a sulfobenzoic acid salt, and a diaryl carbonate ester to a starting temperature of from about 210° C. to about 230° C.;
holding the reaction mixture at a first temperature of from about 170° C. to about 190° C. for a first period of from about 10 to about 20 minutes at a first pressure of from about 900 millibar to about 1500 millibar;
holding the reaction mixture at a second temperature of from about 200° C. to about 220° C. for a second period of from about 20 to about 40 minutes at a second pressure of from about 100 millibar to about 200 millibar; and
holding the reaction mixture at a third temperature of from about 230° C. to about 250° C. for a third period of from about 20 to about 40 minutes at a third pressure of from about 10 millibar to about 30 millibar;
wherein the reaction mixture is heated for a total of from about 90 to about 120 minutes;
to obtain the soluble telechelic sulfonated polycarbonate.

11. The method of claim 10, further comprising:
holding the reaction mixture at a fourth temperature of from about 260° C. to about 280° C. for a fourth period of from about 5 to about 15 minutes at a fourth pressure of from about 2 millibar to about 5 millibar; and
holding the reaction mixture at a fifth temperature of from about 300° C. to about 320° C. for a fifth period of from about 15 to about 25 minutes at a fifth pressure of from about 0.2 millibar to about 1 millibar.

12. The method of claim 11, wherein the starting temperature is about 220° C.;
wherein the first temperature is about 180° C., the first period is about 15 minutes, and the first pressure is about 1000 millibar;
wherein the second temperature is about 210° C., the second period is about 30 minutes, and the second pressure is about 130 millibar
wherein the third temperature is about 240° C., the third period is about 30 minutes, and the third pressure is about 20 millibar
wherein the fourth temperature is about 270° C., the fourth period is about 10 minutes, and the fourth pressure is about 2.5 millibar; and
wherein the fifth temperature is about 310° C., the fifth period is about 20 minutes, and the fifth pressure is about 0.5 millibar.

13. The method of claim 10, wherein the sulfobenzoic acid salt is the phenyl ester of 3-sulfobenzoic acid sodium salt and the diaryl carbonate ester is diphenyl carbonate.

14. The method of claim 10, wherein the diaryl carbonate ester is diphenyl carbonate and the sulfobenzoic acid salt is an activated ester having the structure of Formula (II): 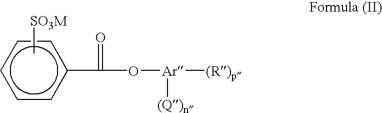
wherein M is an alkali metal; and Ar″ is an aromatic ring; each Q″ is independently selected from alkoxycarbonyl, halogen, nitro, amide, sulfone, sulfoxide, imine, and cyano; n″ is a whole number from 1 up to the number of replaceable hydrogen groups on the aromatic ring Ar″; R″ is selected from alkyl, substituted alkyl, cycloalkyl, alkoxy, aryl, alkylaryl having from 1 to 30 carbon atoms, cyano, nitro, halogen, and carboalkoxy; and p″ is an integer from zero up to the number of replaceable hydrogen groups on the aromatic ring Ar″ minus n″.

15. The method of claim 10, wherein the sulfobenzoic acid salt is the methyl salicyl ester of sulfobenzoic acid sodium salt.
